(19) United States
(12) Patent Application Publication
(10) Pub. No.: US 2024/0176304 A1
(43) Pub. Date: May 30, 2024

(54) WRIST-WORN DEVICE WITH REMOVABLE BEZEL

(71) Applicant: American Exchange Time LLC, New York, NY (US)

(72) Inventors: Adrian Todd Emerson, New Rochelle, NY (US); Noemi Nagi, Delran, NJ (US)

(21) Appl. No.: 18/524,165

(22) Filed: Nov. 30, 2023

Related U.S. Application Data
(60) Provisional application No. 63/428,920, filed on Nov. 30, 2022.

(51) Int. Cl. G04B 45/00; A44C 5/14; G04G 21/02

(52) U.S. Cl. CPC G04B 45/0069; A44C 5/14; G04G 21/025

(57) ABSTRACT

A wrist-worn device includes a main body having one of a retention recess and a retention projection and a bezel configured to cover at least a portion of the main body. The bezel has one other of the retention recess and the retention projection. The at least one retention projection engages with the at least one retention recess to removably attach the bezel to the main body.

### CROSS-REFERENCE TO RELATED APPLICATION

This application claims the benefit of priority to U.S. Provisional Application No. 63/428,920, filed on Nov. 30, 2022. This document is incorporated herein by reference in its entirety.

### FIELD OF INVENTION

The present disclosure relates to wearable personal devices. More specifically, the present disclosure relates to a wrist-worn device with a removable bezel.

### BACKGROUND

Wrist-worn devices such as traditional watches and smart watches are a popular consumer accessory. In addition to the traditional watch function of telling time, smart watches may be used to track activities of a user (e.g., steps taken or distance traveled) and monitor physical attributes of a user (e.g., heart rate or sleep patterns), or may be paired with a smartphone to facilitate communication via text messages or voice calls. The owner of a wrist-worn device may wish to customize the appearance of his or her device during the course of ownership to, for example, match a particular outfit.

### SUMMARY OF THE INVENTION

In one embodiment, a wrist-worn device includes a main body having one of a retention recess and a retention projection and a bezel configured to cover at least a portion of the main body. The bezel has one other of the retention recess and the retention projection. The at least one retention projection engages with the at least one retention recess to removably attach the bezel to the main body.

In another embodiment, a method of customizing a wrist-worn device includes the steps of providing a main body having one of a first retention recess and a first retention projection, and providing a first bezel having one other of the first retention recess and the first retention projection. The method further includes moving the first retention projection into engagement with the first retention recess to removably attach the first bezel to the main body, such that the bezel covers a portion of the main body.

In yet another embodiment a wrist-worn device includes a main body having a plurality of side faces. Each one of the side faces has a retention recess. The device further includes a bezel having a plurality of sides. Each one of the sides has a retention projection. The device further includes a band configured to affix the wrist-worn device to a user. Each one of the retention recesses receives a respective one of the retention projections to removably attach the bezel to the main body such that the bezel covers at least a portion of the main body.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale, and the proportion of certain elements may be exaggerated for the purpose of illustration.

FIG. 1 is a top perspective view of a wrist-worn device and bezel system;

FIG. 2 is a bottom perspective view of the wrist-worn device and bezel system of FIG. 1;

FIG. 3 is a first end view of the wrist-worn device and bezel system of FIG. 1;

FIG. 4 is a second end view of the wrist-worn device and bezel system of FIG. 1;

FIG. 5 is a first side view of the wrist-worn device and bezel system of FIG. 1;

FIG. 6 is a second side view of the wrist-worn device and bezel system of FIG. 1;

FIG. 7 is a top plan view of the wrist-worn device and bezel system of FIG. 1;

FIG. 8 is a bottom plan view of the wrist-worn device and bezel system of FIG. 1;

FIG. 9 is an exploded top perspective view of the wrist-worn device and bezel system of FIG. 1;

FIG. 10 is a bottom plan view of the bezel of the wrist-worn device and bezel system of FIG. 1; and

FIG. 11 is a top plan view of the main body and band of the wrist-worn device and bezel system of FIG. 1.

### DETAILED DESCRIPTION

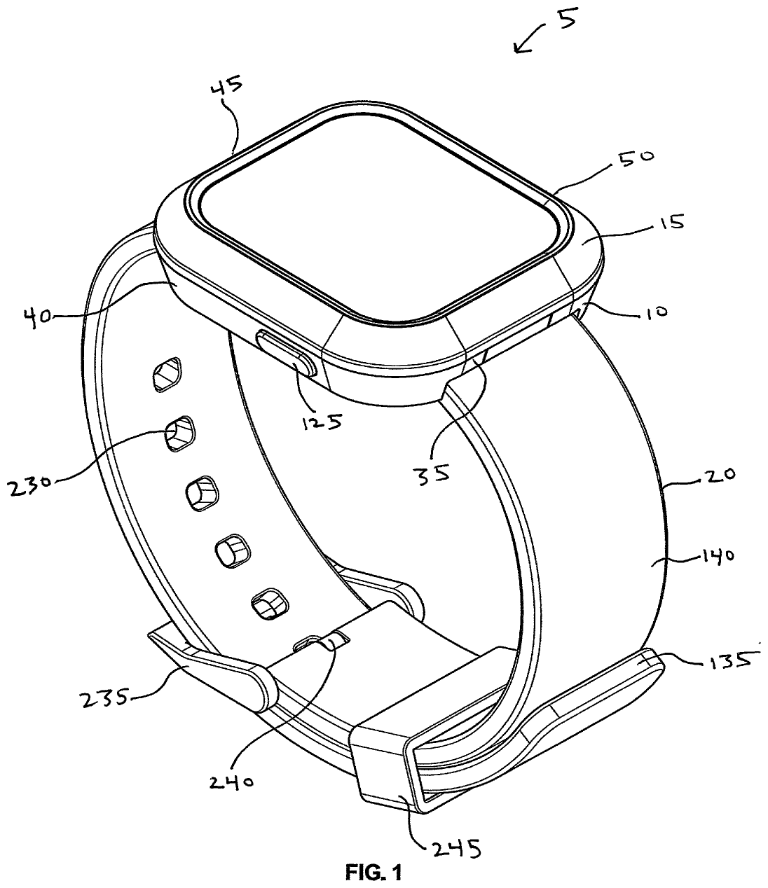

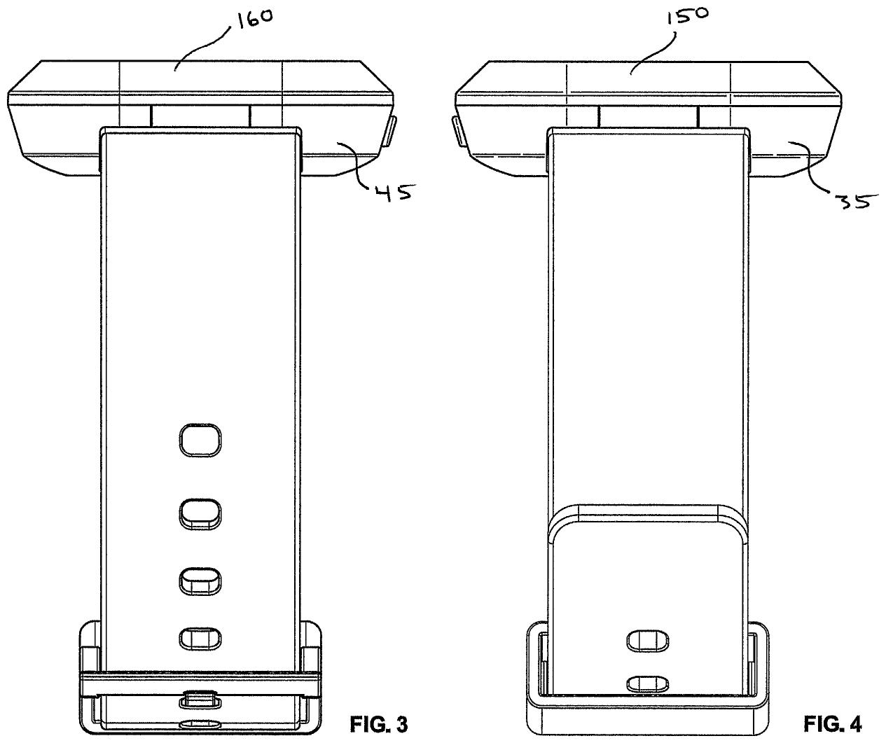

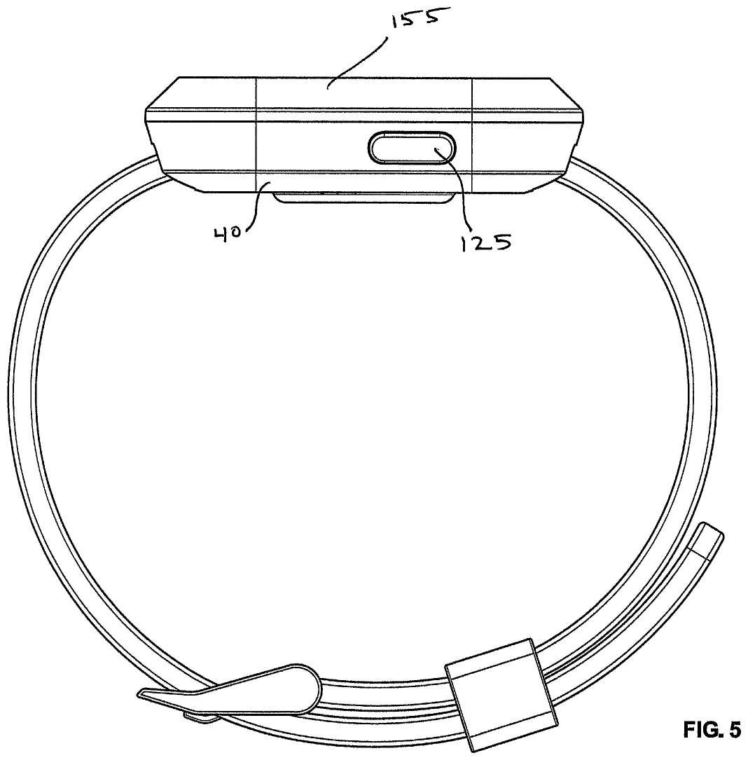

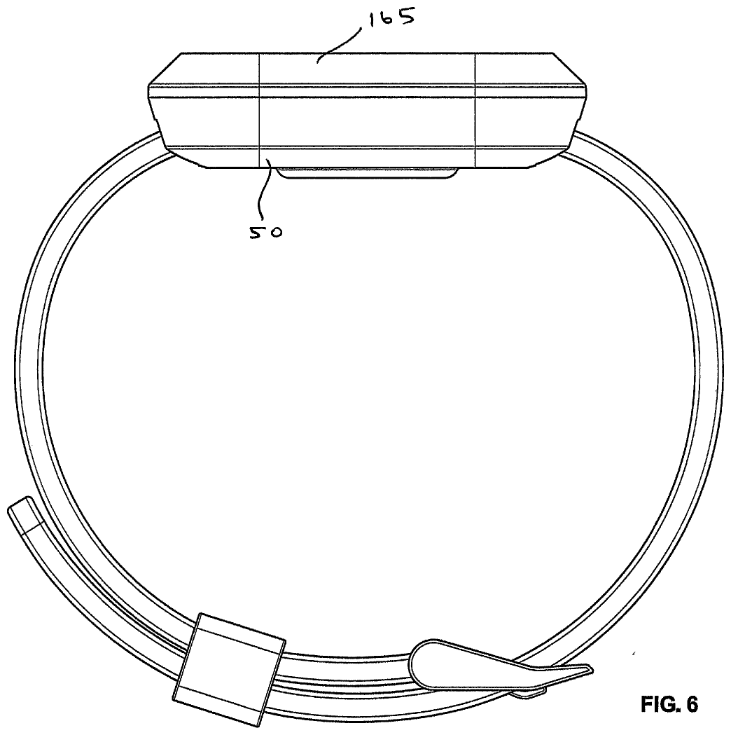

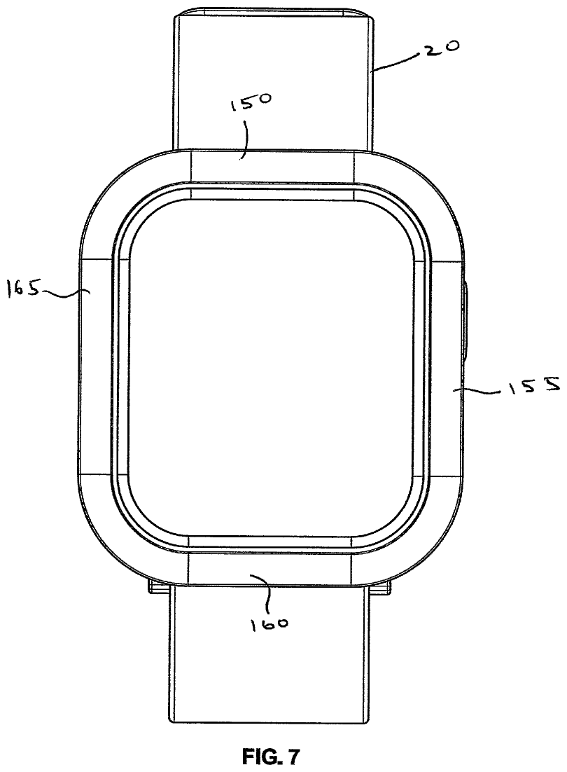

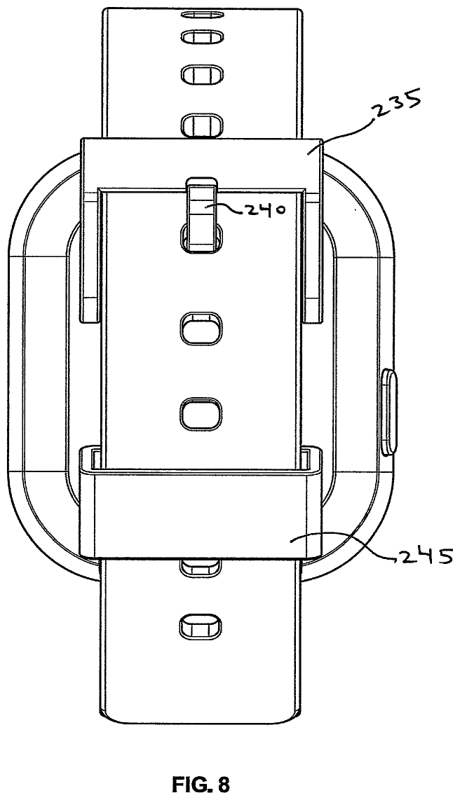

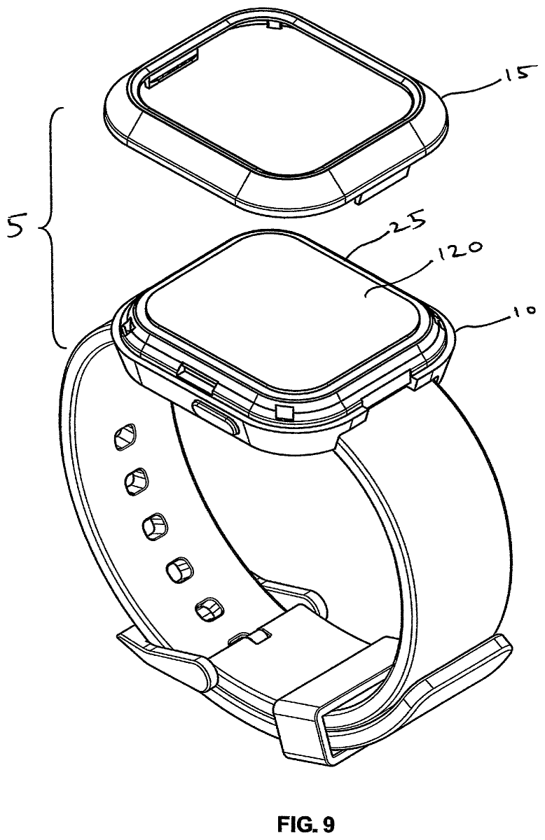

FIGS. 1-11 show one embodiment of a wrist-worn device and bezel system 5. The wrist-worn device and bezel system 5 includes a main body 10, a bezel 15, and a band 20. In the illustrated embodiment the wrist-worn device and bezel system 5 is a smart watch. In alternative embodiments, the wrist-worn device and bezel system may be a standard watch, a health monitor, a fitness tracker, or any other desired device.

The main body 10 includes a front face 25 and a rear face 30. Side faces 35, 40, 45, 50 extend between and interconnect the front face 25 and the rear face 30. In the illustrated embodiment, the main body 10 is substantially square-shaped in plan view with four side faces 35, 40, 45, 50 and rounded corners 55, 60, 65, 70. In alternative embodiments, the main body may have any desired shape or corners with any desired configuration. For example, the main body may be substantially circular-shaped or octagon-shaped in plan view. As another example, the corners of the main body may form right angles without any rounding.

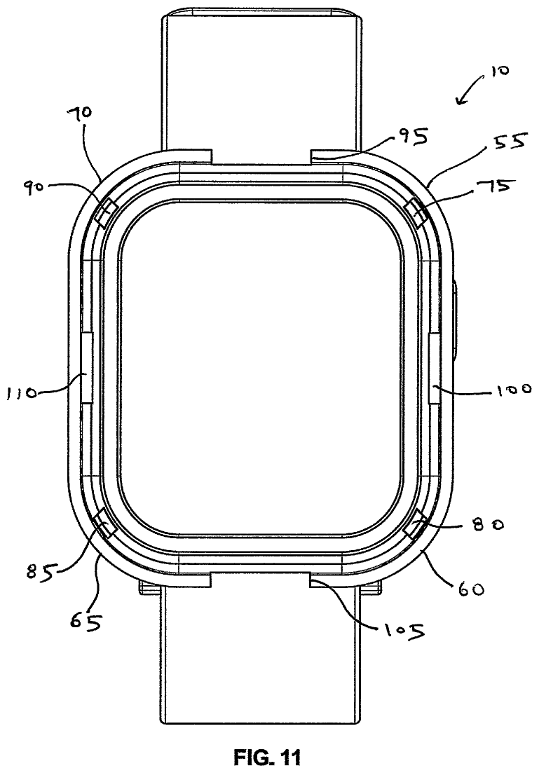

The main body 10 includes a plurality of alignment recesses 75, 80, 85, 90 and a plurality of retention recesses 95, 100, 105, 110 (as shown in FIG. 11). In the illustrated embodiment, the main body 10 includes four alignment recesses 75, 80, 85, 90 provided at the corners 55, 60, 65, 70 of the main body 10, and four retention recesses 95, 100, 105, 110 provided on the side faces 35, 40, 45, 50 of the main body 10. Thus, moving around the main body 10 in a clockwise direction from the perspective shown in FIG. 11, the alignment recesses 75, 80, 85, 90 and the retention recesses 95, 100, 105, 110 alternate with one another. In alternative embodiments, the main body may include a fewer or greater number of alignment recesses, and the alignment recesses may be provided at any desired location on the main body. In other alternative embodiments, the main body may include a fewer or greater number of retention recesses, and the retention recesses may be provided at any desired location on the main body. For example, the main body may include only two alignment recesses and two retention recesses. As another example, the retention recesses may be provided at the corners of the main body and the alignment recesses may be provided on the side faces of the main body.

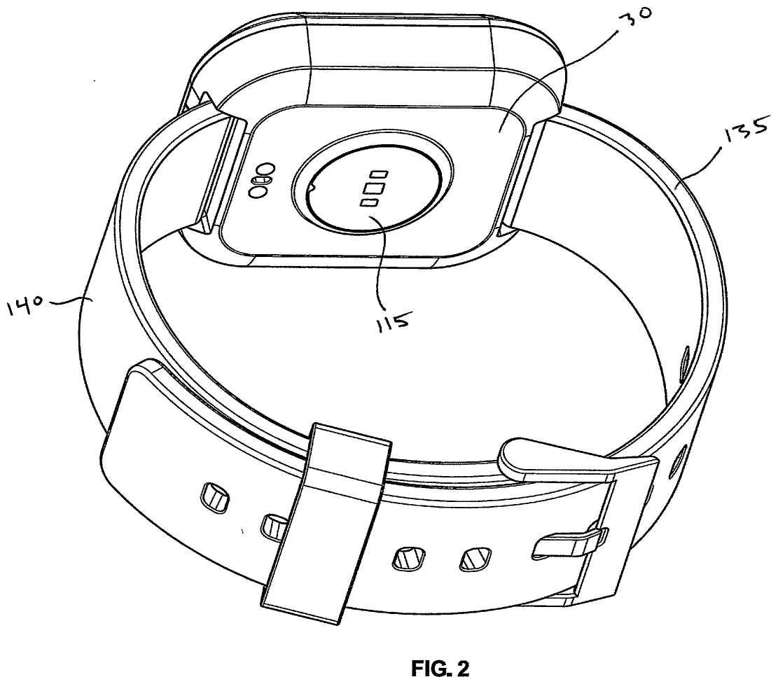

The rear face 30 includes a sensor pad 115 (as shown in FIG. 2). The sensor pad 115 may be used to measure the vital signs of an individual wearing the wrist-worn device and bezel system 5. For example, the sensor pad 115 may be configured to measure the heart rate breathing rate, or blood oxygen level of an individual wearing the wrist-worn device and bezel system 5. In alternative embodiments, the wrist-worn device and bezel system may include multiple sensor pads for measuring different vital signs. In other alternative embodiments, the sensor pad may be omitted.

The front face 25 includes a display 120. The display 120 may show information sensed by the sensor pad 115. For example, the display 120 may show the heart rate of a user wearing the wrist-worn device and bezel system 5. Additionally, the display 120 may show other information including, but not limited to, time, date, steps taken, or distance traveled. In the illustrated embodiment, the shape of the display 120 substantially corresponds to the shape of the main body 10 and is thus substantially square-shaped in plan view. In alternative embodiments, the shape of the display may be different from the shape of the main body. For example, the display may be circular-shaped in plan view while the main body is substantially square-shaped in plan view.

A button 125 is provided on the second side face 40. The button 125 may be used to cycle through the information shown on the display 120. For example, depressing the button 125 once may cause the display 120 to change from showing the time to showing the date, a subsequent depression may cause the display 120 to change to showing user hear rate, and another subsequent depression may cause the display 120 to change again to show time. In alternative embodiments, the button may be provided at any desired location on the main body. In other alternative embodiments, the main body may include additional buttons. In yet another alternative embodiment, a rotatable crown may be disposed on a side face in addition to or instead of a button. In still yet other alternative embodiments, the button may be omitted and the display may be a touchscreen to cycle through information shown on the display.

The bezel 15 includes a plurality of sides 150, 155, 160, 165. In the illustrated embodiment, the shape of the bezel 15 in plan view approximates the shape of the main body 10, and thus is substantially square-shaped with four sides 150, 155, 160, 165 and rounded corners 170, 175, 180, 185. It is understood, however, that should the shape of the main body 10 change, the shape of the bezel 15 would likewise change. In alternative embodiments, the bezel may have a shape that is different from a shape of the main body. For example, the main body may be substantially circular-shaped while the bezel is octagon-shaped.

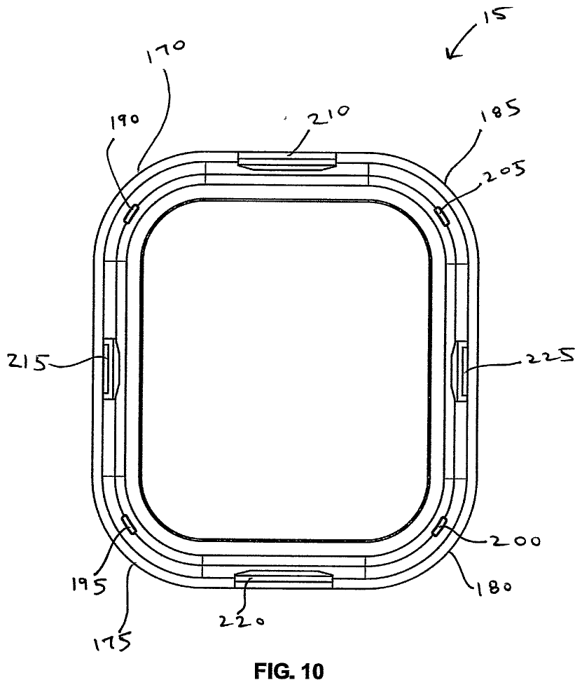

The bezel 15 includes a plurality of alignment projections 190, 195, 200, 205 and a plurality of retention projections 210, 215, 220, 225 (as shown in FIG. 10). In the illustrated embodiment, the bezel 15 includes four alignment projections 190, 195, 200, 205 extending from the corners 170, 175, 180, 185 of the bezel 15, and four retention projections 210, 215, 220, 225 extending from the sides 150, 155, 160, 165 of the bezel 15. The position of the alignment projections 190, 195, 200, 205 and the retention projections 210, 215, 220, 225 on the bezel 15 mirror the position of the alignment recesses 75, 80, 85, 90 and retention recesses 95, 100, 105, 110 on the main body 10. It is understood, however, that any changes in the number of, or location of, alignment recesses 75, 80, 85, 90 or retention recesses 95, 100, 105, 110 may be reflected by a similar change in the number of, or location of, alignment projections 190, 195, 200, 205 or retention projections 210, 215, 220, 225, respectively. In alternative embodiments, the location of the alignment projections and alignment recesses may be switched so that the alignment projections are provided on the main body and the alignment recesses are provided on the bezel. In other alternative embodiments, the number of alignment projections or retention projections and the number of alignment recesses or retention recesses may not equal one another. For example, the main body may include four alignment recesses, but the bezel may only include two alignment projections.

The retention recesses 95, 100, 105, 110 receive the retention projections 210, 215, 220, 225 to attach the bezel 15 to the front face 25 of the main body 10 such that the bezel 15 covers at least a portion of the main body 10. The alignment recesses 75, 80, 85, 90 may cooperate with the alignment projections 190, 195, 200, 205 to align the bezel 15 with the main body 10 during attachment of the bezel 15 to the main body 10 and may provide stability to the connection between the bezel 15 and the main body 10 once the bezel 15 is attached to the front face 25.

In the illustrated embodiment, the retention projections 210, 215, 220, 225 are flexible arms that are substantially hook-shaped and the retention recesses 95, 100, 105, 110 are undercuts in the main body 10. Additionally, in the illustrated embodiment, the alignment projections 190, 195, 200, 205 are substantially rigid posts extending from the bezel 15 with a substantially rectangular-shaped cross section (as shown in in FIG. 10) and the alignment recesses 75, 80, 85, 90 are depressions in the main body having a corresponding geometry of a substantially rectangular-shaped cross section (as shown in FIG. 11). The hook-shaped retention projections 210, 215, 220, 225 flex as they move into engagement with the undercut retention recesses 95, 100, 105, 110. Simultaneously, the alignment recesses 75, 80, 85, 90 receive the alignment projections 190, 195, 200, 205 to ensure proper alignment between the bezel 15 and the main body 10 while also providing stability to the connection therebetween. In alternative embodiments the retention projections and recesses and the alignment projections and recesses may have any desired arrangement.

The band 20 includes a first band part 135 and a second band part 140. The first band part 135 is attached to the first side face 35 of the main body 10. The second band 140 part is attached to the third side face 45 of the main body 10. In alternative embodiments, the band may include only a single band part. In other alternative embodiments, the band may be attached to any desired part of the main body.

The first band part 135 includes a plurality of adjustment holes 230. The second band part 140 includes a buckle 235, a buckle tongue 240, and a loop 245. In alternative embodiments, the band may have any desired arrangement. For example, the band may include a clasp rather than a buckle. As another example, the band may have a one-piece construction and be manufactured out of an elastic material. As yet another example, the first band part and the second band part may be provided with hook and loop fasteners or magnetic fasteners.

When a user desires to wear the wrist-worn device 5, he or she may place the first and second band parts 135, 140 around his or her wrist. Then, the first band part 135 is inserted into the buckle 235, and then the buckle tongue 240 is inserted into one of the adjustment holes 230, thus affixing the wrist-worn device 5 to the user. The loop 245 may receive any free length of the first band part 135.

The user may change the appearance of his or her wrist-worn device 5 by, first, separating the bezel 15 from the main body 10. According to one example embodiment, the retention projections 210, 215, 220, 225 and retention recesses 95, 100, 105, 110 are configured to allow removal of the bezel 15 from the main body 10 by simply pulling the bezel 15 away from the front face 25 of the smart watch 5 by the force of the user's hands alone. According to this example, as discussed above, the retention projections 210, 215, 220, 225 are flexible arms. A user may directly manipulate the retention projection 210, 215, 220, 225 to move them out of engagement with the undercut retention recesses 95, 100, 105, 110, thereby allowing removal of the bezel 15 from the main body 10. According to another example embodiment, the retention projections 210, 215, 220, 225 and the retention recesses 95, 100, 105, 110 are configured so that a user must directly manipulate at least one of the projections and the recesses before the bezel 15 may be removed from the main body 10. According to this example, the bezel 15 cannot be removed from the main body 10 by simply pulling the bezel 15 away from the front face 25 of the smart watch 5. In still yet another example embodiment, a specialized tool may be required to manipulate the retention projections 210, 215, 220, 225 or the retention recesses 95, 100, 105, 110 before the bezel 15 may be removed from the main body 10.

The foregoing describes a wrist-worn device 5 that allows a user to quickly and easily customize the appearance of his or her device by replacing the bezel 15. Additionally, it may allow the user to repair the wrist-worn device 5 in the event the bezel 15 is damaged.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. For example, the bezel may be secured to the main body using a magnetic connection rather than the retention projections and the retention recesses described herein. As another example, the removable bezel concept may be applied to other devices such as, for example, smart phones. Accordingly, departures may be made from such details without departing from the spirit or scope of the applicant's general inventive concept.

What is claimed is:

1. A wrist-worn device comprising:
a main body including one of a retention recess and a retention projection; and
a bezel configured to cover at least a portion of the main body, the bezel including one other of the retention recess and the retention projection;
wherein the at least one retention projection engages with the at least one retention recess to removably attach the bezel to the main body.

2. The wrist-worn device of claim 1, wherein the main body includes one of an alignment recess and an alignment projection, and wherein the bezel includes one other of the alignment recess and the alignment projection, the alignment recess and the alignment projection being configured to align the bezel with the main body during attachment of the bezel to the main body.

3. The wrist-worn device of claim 2, wherein the main body includes a plurality of retention recesses and a plurality of alignment recesses, and wherein the bezel includes a plurality of retention projections and a plurality of alignment projections.

4. The wrist-worn device of claim 3, wherein the main body is substantially square shaped in plan view, and wherein the plurality of retention recesses are provided on side faces of the main body and the plurality of alignment recesses are provided at corners of the main body.

5. The wrist-worn device of claim 3, wherein the bezel is substantially square shaped in plan view, and wherein the plurality of retention projections are provided on sides of the bezel and the plurality of alignment projections are provided at corners of the bezel.

6. The wrist-worn device of claim 1, wherein the main body includes a display on a front face and a sensor pad on a rear face.

7. The wrist-worn device of claim 1, further comprising a band that is configured to affix the wrist-worn device to a user.

8. The wrist-worn device of claim 7, wherein the band includes a first band part and a second band part, the first band part having at least one adjustment hole, the second band part having a buckle and buckle tongue, the adjustment hole being configured to receive the buckle tongue.

9. The wrist-worn device of claim 1, wherein the main body has a first shape in plan view and the bezel has a second shape in plan view, the first shape being the same as the second shape.

10. The wrist-worn device of claim 1, wherein the main body and the bezel are each substantially square-shaped in plan view.

11. A method of customizing a wrist-worn device comprising the steps of:
providing a main body including one of a first retention recess and a first retention projection;
providing a first bezel including one other of the first retention recess and the first retention projection; and
moving the first retention projection into engagement with the first retention recess to removably attach the first bezel to the main body, such that the bezel covers a portion of the main body.

12. The method of claim 11, wherein the main body includes the first retention recess and the first bezel includes the first retention projection, the method further comprising the steps of:
providing a second bezel including a second retention projection;
moving the moving the first retention projection out of engagement with the retention recess to remove the first bezel from the main body; and
moving the second retention projection into engagement with the first retention recess to removably attach the second bezel to the main body.

13. The method of claim 11, wherein the step of providing the main body includes providing the main body with one of an alignment recess and an alignment projection, and wherein the step of providing the first bezel includes providing the first bezel with one other of the alignment recess and the alignment projection, the alignment recess and the alignment projection being configured to align the first bezel with the main body during the step of moving the first retention projection into engagement with the first retention recess to removably attach the first bezel to the main body.

14. The method of claim 11, further comprising the step of providing a band connected to the main body, the band having a first band part and a second band part, the first band part having at least one adjustment hole, the second band part having a buckle and buckle tongue, the adjustment hole being configured to receive the buckle tongue.

15. The method of claim 1, wherein the step of providing the main body includes providing a display on a front face and a sensor pad on a rear face.

16. A wrist-worn device comprising:
a main body including a plurality of side faces, each one of the side faces having a retention recess;
a bezel including a plurality of sides, each one of the sides having a retention projection; and
a band configured to affix the wrist-worn device to a user;
wherein each one of the retention recesses receives a respective one of the retention projections to removably attach the bezel to the main body such that the bezel covers at least a portion of the main body.

17. The wrist-worn device of claim 16, wherein the main body includes a plurality of alignment recesses and the bezel includes a plurality of alignment projections, the alignment recesses and the alignment projections being configured to align the bezel with the main body during attachment of the bezel to the main body.

18. The wrist-worn device of claim 16, wherein the main body has a first shape in plan view and the bezel has a second shape in plan view, the first shape being the same as the second shape.

19. The wrist-worn device of claim 16, wherein the main body includes a display on a front face and a sensor pad on the rear face.

20. The wrist-worn device of claim 16, wherein the band includes a first band part and a second band part, the first band part having at least one adjustment hole, the second band part having a buckle and buckle tongue, the at least one adjustment hole being configured to receive the buckle tongue.
